(19) United States
(12) Patent Application Publication
(10) Pub. No.: US 2013/0264954 A1
(43) Pub. Date: Oct. 10, 2013

(54) ENERGY-SAVING ILLUMINATION APPARATUS AND METHOD THEREOF

(71) Applicants: CHIA-TIN CHUNG, MIAOLI COUNTY (TW); SHIH-NENG TAI, TAOYUAN COUNTY (TW)

(72) Inventors: CHIA-TIN CHUNG, MIAOLI COUNTY (TW); SHIH-NENG TAI, TAOYUAN COUNTY (TW)

(73) Assignee: PARAGON SEMICONDUCTOR LIGHTING TECHNOLOGY CO., LTD, NEW TAIPEI CITY (TW)

(21) Appl. No.: 13/475,980

(22) Filed: May 19, 2012

(30) Foreign Application Priority Data
Apr. 5, 2012 (TW) 101112031

(51) Int. Cl. H05B 37/02

(52) U.S. Cl. 315/186

(57) ABSTRACT

An energy-saving illumination apparatus adapted to receive an input power includes a light unit, a detection unit, a dimming unit, and a control unit. The light unit has a plurality of light sets and a switch unit connecting the light sets in parallel and/or serial connections. The detection unit is for detecting the status of the input power. The dimming unit is for controlling the current of the light unit. The control unit is for controlling the switch unit according to the detection result of the detection unit and making the turn-on voltage of the light unit be changed along with the input power. The control unit controls duty cycle of pulse width modulation (PWM) signal and transmits the PWM signal to the dimming unit. The dimming unit adjusts the current which conducts and makes the light unit emit light to be changes along with the duty cycle.

### BACKGROUND OF THE INVENTION

1. Field of the Invention

The present invention relates to an energy-saving illumination apparatus and a method thereof; in particular, to a light emitting diode (LED) energy-saving illumination apparatus and method thereof.

2. Description of Related Art

Because that the LED has the properties of low power consumption, high brightness, and long working lifetime, it is broadly used in all kinds of energy-saving illumination apparatuses. Please refer to FIG. 1 which is a schematic diagram of an energy-saving illumination apparatus. The apparatus includes a rectification circuit 90, a switch 92, two light sets 94 and 96, and a current source 98. Each light set 94 or 96 includes several LEDs connected serially. For the convenience of explanation, the rectification circuit 90 may be a full-wave rectification circuit, thus the AC power may be converted into pulse DC and be provided to the LEDs as the input power. When several serially connected LEDs are conducted, the current source 98 may provide steady current to the LEDs of the light sets 94 and 96.

However, the energy-saving illumination apparatuses usually use group loop control manner, and use the switch 92 for controlling the conductions of the light set 94 and/or the light set 96. For example, the user may operate the switch 92 by one time for conducting and turning on the light set 94, operate the switch 92 by two times for conducting and turning on the light set 96, and operate the switch 92 by three times for conducting and turning on both the light sets 94 and 96, etc.

Therefore, the energy-saving illumination apparatuses may cause the phenomenon of unequal region brightness. For example, when the light set 94 emits light, the region brightness at the location of the light set 94 is lighter than the region brightness at the location of the light set 96 which is not conducting. Even when the light is diffused by placing the light source at higher places, the region brightness of the light set 96 is still not enough, which causes unequal region brightness.

In addition to the described problem, if the mentioned conventional manner is used in the LED energy-saving illumination apparatus, some of the LEDs may be used frequently while others not, which causes the unequal lifetime or over-current damages of the LEDs.

### SUMMARY OF THE INVENTION

The present invention is for providing energy-saving illumination apparatus and method, in order to solve the aforementioned problems.

The present invention discloses an energy-saving illumination apparatus which receives an input power. The apparatus includes a light unit, a detection unit, a dimming unit, and a control unit. The light unit has several light sets and a switch unit. The switch unit is for connecting the light sets with one another in serial and/or parallel connections. The detection unit is for detecting a status of the input power inputting into the light unit. The dimming unit is coupled to the light unit for controlling the current of the light unit. The control unit is coupled between the detection unit, the switch unit, and the dimming unit, for controlling the switch unit, in order to make the turn-on voltage of the light unit be changed along with the input power. The control unit controls the switch unit according to a detection result of the detection unit, for making the turn-on voltage of the light unit be changed along with the input power. Moreover, the control unit controls a duty cycle of a pulse width modulation (PWM) signal, and transmits the PWM signal to the dimming unit, thus the dimming unit may adjust the current conducting and making the light unit emit light to be changed along with the duty cycle of the PWM signal.

In an embodiment of the present invention, the control unit controls the changes of the duty cycle of the PWM signal according to a brightness adjustment signal.

In an embodiment of the present invention, the control unit generates the brightness adjustment signal when the detection unit detects the time of the input power controlled by a switch for stopping inputting into the light unit is kept within a predetermined time range.

In an embodiment of the present invention, the control unit includes a counting circuit and a switching circuit. The counting circuit counts the time that the input power stops inputting into the light unit according to the detection result of the detection unit. The counting circuit further generates the brightness adjustment signal when the time of the input power stopping inputting into the light unit lies within the predetermined time range. The switching circuit adjusts the duty cycle of the PWM signal according to the brightness adjustment signal.

In an embodiment of the present invention, the controlling of the control unit which changes the duty cycle of the PWM signal is by selecting one of the predetermined duty cycles.

In an embodiment of the present invention, the energy-saving illumination apparatus further includes a current source coupled between the light unit and the dimming unit, for providing the current making the light unit conduct and emit light.

In an embodiment of the present invention, the brightness adjustment signal is inputted by a button circuit connecting to the control unit.

In an embodiment of the present invention, the brightness adjustment signal is wirelessly transmitted from a wireless transmitter to the control unit.

In an embodiment of the present invention, the control unit acquires a cycle time of the input power from the detection unit, and sets several sets of predetermined times in the cycle time. Each set of predetermined times is correspondence to a circuit control manner of the switch unit. When the time counting matches one set of the predetermined times, the control unit may control the switch unit according to the circuit control manner corresponding to the set of predetermined times.

In an embodiment of the present invention, the control unit acquires the voltage changes of the input power from the detection unit, and determines whether the voltage of the input power matches a predetermined value. If the determination result is positive, the control unit controls the switch unit according to the circuit control manner corresponding to the predetermined value.

The present invention discloses an energy-saving illumination method which uses a control unit for controlling a light unit and a dimming unit. The light unit has several light sets and a switch unit. The switch unit is for making the light sets be connected with one another in serial and/or parallel connections. The dimming unit is for controlling the light unit to use a current source. The method includes the step of detecting a status of an input power inputting into the light unit. The input power is a pulse DC. According to the detection result, the control unit controls the switch unit for making the turn-on voltage of the light unit be changes along with the input power. The control unit provides a PWM signal to the dimming unit, and controls a duty cycle of the PWM signal, for making the dimming unit adjust the current turning on the light unit to be changed along with the duty cycle of the PWM signal.

Through the aforementioned embodiments, the present invention may have the following efficacies. As to the energy-saving illumination apparatus, the PWM signal may be adjusted for making the light unit to emit different levels of illumination brightness. Thus, the energy-saving illumination apparatus may wholly output different brightness, for solving the problem of unequal region brightness.

For further understanding of the present disclosure, reference is made to the following detailed description illustrating the embodiments and examples of the present disclosure. The description is only for illustrating the present disclosure, not for limiting the scope of the claim.

### BRIEF DESCRIPTION OF THE DRAWINGS

The drawings included herein provide further understanding of the present disclosure. A brief introduction of the drawings is as follows:

FIG. 1 shows a schematic diagram of an energy-saving illumination apparatus;

FIG. 2 shows a block diagram of an energy-saving illumination apparatus according to an embodiment of the present invention;

FIG. 3 shows a flow chart of an energy-saving illumination method;

FIG. 4 shows a block diagram of an energy-saving illumination apparatus with a power supply according to an embodiment of the present invention;

FIG. 5-1 shows a flow chart of an energy-saving illumination method according to an embodiment of the present invention;

FIG. 5-2 shows a flow chart of an energy-saving illumination method according to an embodiment of the present invention;

FIG. 6 shows a waveform diagram of a PWM signal according to an embodiment of the present invention; and

FIG. 7 shows a block diagram of an energy-saving illumination apparatus according to an embodiment of the present invention.

### DETAILED DESCRIPTION OF THE PREFERRED EMBODIMENTS

The present invention relates to an energy-saving apparatus and a method thereof. The apparatus may be illumination arrays including several LEDs. By changing the parallel and/or serial connections between the LEDs, the turn-on voltage of the illumination arrays may be adjusted. The apparatus may transmit PWM signal to a dimming through a control unit, thus the dimming unit may control the current conducting and making the LEDs emit light according to the PWM signal. The LEDs may output illumination brightness according to the magnitude of the current controlled by the dimming unit.

[An Exemplary Embodiment of an Energy-Saving Illumination Apparatus According to the Present Invention]

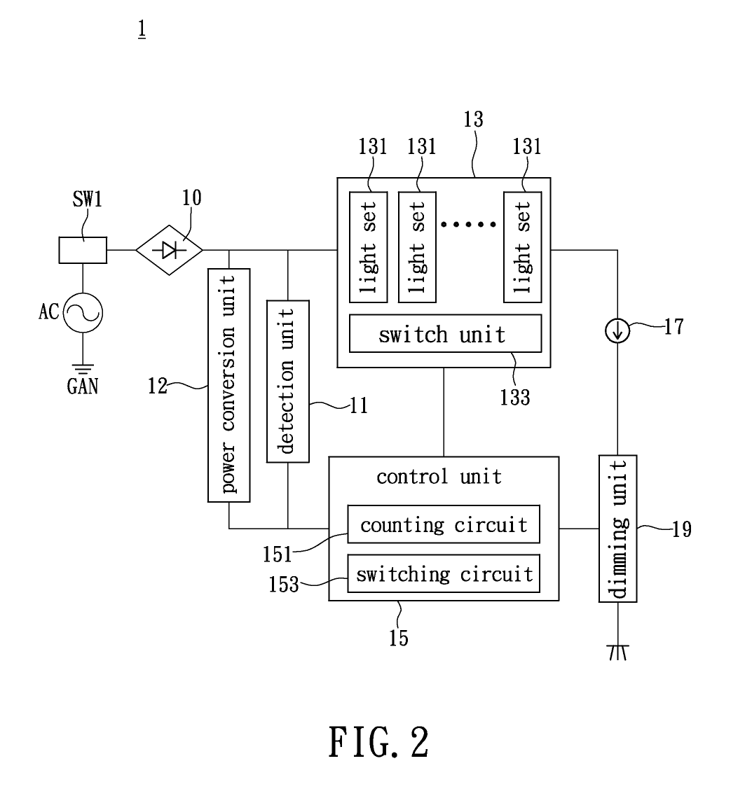

FIG. 2 shows a block diagram of an energy-saving illumination apparatus according to an embodiment of the present invention. Please refer to FIG. 2. The energy-saving illumination apparatus 1 may include a switch SW1, a rectification unit 10, a detection unit 11, a power conversion unit 12, a light unit 13, a control unit 15, a current source 17, and a dimming unit 19. The control unit 15 is coupled between the detection unit 11, the power conversion unit 12, the light unit 13, and the dimming unit 19.

The switch SW1 is coupled between the AC power and the rectification unit 10, and may serve as the switch for turning on or off the AC power. Thus, the user may operate the switch SW1 according to the indoor illumination needs. For example, the user may operate the switch SW1 and let the switch SW1 be set to ON status, and the energy-saving illumination apparatus 1 may output illumination brightness accordingly. Of course, if the switch SW1 is set to OFF status, the energy-saving illumination apparatus 1 may be turned off. Therefore, the user may let the energy-saving illumination apparatus 1 output different illumination brightness or several levels of brightness by operating the switch SW1.

In addition, in other embodiments, the switch SW1 may be coupled between the rectification unit 10 and the light unit 13. Of course, the user may also make the energy-saving illumination apparatus 1 output brightness by operating the switch SW1. Thus, the switch SW1 may serve as the switch for changing the ON status and OFF status of the AC power or the input power. For explanation convenience, the switch SW1 in this embodiment is coupled between the AC power and the rectification unit 10, and the arrangement, location, and operation modes of the switch SW1 are just an example which does not limit the scope of the present invention.

The rectification unit 10 may be AC/DC power rectification circuit or a full-wave rectification circuit, for rectifying the waveform of the AC power and converting it into the input power which may be used by the light unit 13. The input power may be full-wave pulse direct current (DC). It's worth noting that the rectification unit 10 may also be a half-wave rectification circuit which does not be limited thereby.

The detection unit 11 is used for detecting the status of the input power used by the light unit 13, for example, detecting the phase changes or voltage changes of the input power. Specifically, the detection unit 11 may be a phase detection circuit or a voltage detection circuit, but the scope of the present invention is not restricted thereby. The input power may be a pulse DC which is acquired after rectifying the AC power. Moreover, the pulse DC may be a full-wave or half-wave pulse DC, and the following description uses a full-wave DC as an example.

Practically, the detection unit 11 may detect the ON or OFF statuses of the switch SW1. For example, the detection unit 11 may be a phase detection circuit. When the switch SW1 is set to OFF status, the detection unit 11 may detect a power with zero-phase, and when the switch SW1 is set to ON status, the detection unit 11 may detect the phase of the power. For more examples, the detection unit 11 may be a voltage detection circuit, when the switch SW1 is set to OFF status, the detection unit 11 may detect the power with zero voltage level, and when the switch SW1 is set to ON status, the detection unit 11 may detect the voltage level of the power.

The power conversion unit 12 is coupled between the rectification unit 10 and the control unit 15, for power converting the input power to output a DC power with fixed voltage to the control unit 15. For example, the 110 volts DC power may be converted into 5 volts DC power and then be provided to the control unit 15.

In addition, the power conversion unit 12 may be a capacitor. When the switch SW1 is doing ON-OFF operations, the power conversion unit 12 provides a maintaining power to the control unit 15, which makes the control unit 15 work normally within the predetermined time range. It is worth nothing that, in other embodiment, the power conversion unit 12 may be a battery, rechargeable battery, or other power provider. The implementation of the power conversion unit 12 is not limited in the present invention, and the one skilled in the art may freely design it according to the actual needs.

The light unit 13 may include several light sets 131 and a switch unit 133. The light set 131 may include several LEDs connecting serially, and may receive the input power which makes it forward-conducting. The switch unit 133 may be used for changing the circuit connection relations between the light sets 131. The switch unit 133 may include several switch component and/or relative circuit components (such as a one-way conduction component).

Practically, the switch unit 133 may form several kinds of circuit connection relations between the light sets 131. For example, through the controlling of the switch unit 133, a light set 131 may be connected with another one or several light sets 131 in serial and/or parallel connections. Alternatively, the light sets 131 may be separated into several groups. Each group includes several light sets 131 which are connected with one another in serial and/or parallel connections, and each of the groups may also be connected with one another in serial and/or parallel connections. The mentioned circuit relations between each of the light sets 131 are just an example, and the scope of the present invention is not limited thereby.

It's worth noting that each LED is connected serially. Thus, the user may freely design the number of serially connected LEDs of each light set 131, for further designing the turn-on voltage of each light set 131. In addition, the turn-on voltages of the light sets 131 in parallel connections are lower than those in serial connections. Thus, if the turn-on voltage of the light unit 13 is relatively low, the number of the light sets 131 which are in parallel connections may be relatively larger, thus the current source may need to provide relatively larger conduction current. On the other hand, if the turn-on voltage of the light unit 13 is relatively high, the number of the light sets 131 which are in serial connection may be relatively larger, thus the current source may provide relatively smaller conduction current.

The control unit 15 may be an MCU chip. The control unit 15 controls the switch unit 133 according to the detection result of the detection unit 11, for connecting the circuits of the light sets 131 of the light unit 13, and for adjusting according to the status (such as voltage or phase) of the input power to make the light unit 13 conduct. For example, when the voltage level of the input power is higher than the voltage of one light set 131 or the voltage of several serially connected light sets 131, the control unit 15 may acquire the information from the detection unit 11, and may control the switch unit 133 for connecting the light sets 131 in serial or parallel connections for emitting light. In one embodiment, the control unit 15 may set one or several sets of predetermined values as the determination conditions of the switch unit 133. The predetermined value may be a voltage value or a time value, but is not restricted thereby.

In addition, the control unit 15 controls the changes of the duty cycle of the PWM signal according to a brightness adjustment signal. Specifically, the control unit 15 generates the brightness adjustment signal when the detection unit 11 detects that the time of the input power controlled by the switch SW1 stopping inputting into the light unit 13 is kept within a predetermined time range. Thus, the brightness adjustment signal changes according to the ON-OFF operations of the switch SW1. For example, the brightness adjustment signal is set as the Nth signal according to the ON-OFF operations of the switch SW1, and N is a positive integer. And the control unit 15 correspondingly generates the Nth PWM signal according to the changes of the duty cycle of the PWM signal controlled by the Nth signal.

Practically, the switch SW1 executes the ON-OFF operations. If the time when the switch SW1 is set at OFF status within the predetermined time range such as the time range between a first predetermined time and a second predetermined time, the control unit 15 generates the brightness adjustment signal according to the ON-OFF operation of the switch SW1. Then the control unit 15 controls the changes of the duty cycle of the PWM signal according to the brightness adjustment signal, and transmits the PWM signal to the dimming unit 19, which allows the dimming unit 19 to change the currents making the light unit 13 emit light along with the duty cycle of the PWM signal.

It is worth noting that the controlling of the control unit 15 controls the change of the duty cycle of the PWM signal is by selecting one from several different predetermined duty cycles. Specifically, the control unit 15 may have N numbers of different predetermined duty cycles. Of course, the control unit 15 may also have the PWM signals with N numbers of predetermined duty cycles. Moreover, the control unit 15 controls the changes of the duty cycle of the PWM signal according to the brightness adjustment signal. Therefore, the PWM signals of N numbers of different predetermined duty cycles are corresponding to N numbers of different brightness adjustment signals, and N is a positive integer.

For example, the control unit 15 has three PWM signals with different predetermined duty cycles, so N equals to 3. The three PWM signals with different duty cycles are corresponding to three different brightness adjustment signals. The brightness adjustment signal may be the first signal, the second signal, or the third signal. The brightness adjustment signal is one selected from the group of the first signal, the second signal, and the third signal. Thus, the change of the duty cycle of the PWM signal is selected from one of the three different predetermined duty cycles. For example, the change of the duty cycle of the PWM signal may be distinguished as the first PWM signal, the second PWM signal, or the third PWM signal.

Specifically, the control unit 15 has a counting circuit 151 and a switching circuit 153. The counting circuit 151 counts the time that the input power stops inputting into the light unit 13 according to the detection result of the detection unit 11. When the time that the input power stops inputting into the light unit 13 is within the predetermined time range, the counting circuit 151 may generate the brightness adjustment signal. The switching circuit 153 may be a PWM circuit, for adjusting the duty cycle of the PWM signal according to the brightness adjustment signal.

For example, if the time that the pulse voltage of the input power is at zero voltage level is located within the time range between the first predetermined time and the second predetermined time, the counting circuit 151 may increase the counting value for generating brightness adjustment signal. When the counting value of the counting circuit 151 is one, the brightness adjustment signal is the first signal. When the counting value of the counting circuit 151 is two, the brightness adjustment signal is the second signal. And when the counting value of the counting circuit 151 is N, the brightness adjustment signal is the Nth signal. In addition, the counting circuit 151 may provide the brightness adjustment signal to the switching circuit 153, and the switching circuit 153 may adjust the duty cycle of the PWM signal according to the brightness adjustment signal. For example, the switching circuit 153 may adjust the duty cycle of the PWM signal according to the third signal, and generates the third PWM signal accordingly.

In addition, the control unit 15 transmits the PWM signal to the dimming unit 19 through the switching circuit 153. The dimming unit 19 controls the current source 17 according to the PWM signal, which allows the current source 17 provides the current to the light unit 13 for light emitting. Thus, the light unit 13 outputs illumination brightness according to the magnitude of the current. For example, the control unit 15 adjusts the duty cycle of the PWM signal according to the brightness adjustment signal. The brightness adjustment signal may be the Nth signal. The control unit 15 transmits the PWM signal to the dimming unit 19, and the dimming unit 19 controls the light unit 13 for outputting the Nth illumination brightness according to the magnitude of the current.

It is worth noting that the control unit 15 may include a predetermined mode and a energy-saving mode, and the present embodiment makes the control unit 15 enter and set the energy-saving mode by using the ON-OFF operations of the switch SW1. The energy-saving mode controls the changes of the duty cycle of the PWM signal according to the brightness adjustment signal. Practically, the predetermined mode of the control unit 15 set the first signal as the brightness adjustment signal. The brightness adjustment signal are serially switched to the Nth signal, and when the number N exceeds a upper limit value, it is restored to 1.

For example, the switching circuit 153 may generate five kinds of PWM signals with different duty cycles, and the corresponding brightness adjustment signal may be respectively set as the first signal, the second signal, the third signal, the fourth signal, and the fifth signal. Thus, the fifth signal is the upper limit signal of the switching circuit 153, and the upper limit value is 5. When the Nth signal exceed the fifth signal, they may be restored to the predetermined first signal. Therefore, the first signal to the fifth signal may form a loop.

The brightness adjustment signal of the predetermined mode in this embodiment may set from the first signal serially switched to the Nth signal. For example, if the number N is 3, the first signal may be changed to the second signal, the second signal may be changed to the third signal, and the third signal may be changed to the first signal. It is worth noting that, in other embodiments, the brightness adjustment signal of the predetermined mode may be set as the Nth signal, or, the first signal of the energy-saving mode may not need to be switched serially to the Nth signal. The brightness adjustment signal of the energy-saving mode may be set according to the requirements of the users. The programming of the energy-saving mode or the predetermined mode is not limited in the present invention, and the one skilled in the art may design it freely according to the actually needs.

It is worth noting that, in other embodiments, the brightness adjustment signal is inputted by a button circuit connecting with the control unit 15, or is received wirelessly from a wireless transmitter to the control unit 15. For example, the user may use infrared remote control device, wireless radio frequency device, or Bluetooth radio frequency for controlling the switch SW1, and making the switch SW1 execute ON-OFF operations. Alternatively, the user may provide a signal to the control unit 15 through the button circuit, infrared remote control device, wireless radio frequency device, or Bluetooth radio frequency device connecting with the control unit 15, which makes the control unit 15 enter and set the energy-saving mode. Using the switch SW1 for setting the energy-saving mode of the control unit 15 are only for explanation, and the scope of the present invention is not limited by FIG. 2.

The current source 17 is coupled between the light unit 13 and the dimming unit 19, for providing steady power when the light sets 131 of the light unit 13 are conducting. Practically, the current source 17 makes the magnitudes of the currents flowing through each of the LEDs of the light unit 13 equal to one another, and effectively avoids over-magnitude currents from flowing through each of the LEDs.

The dimming unit 19 is coupled between the current source 17 and the control unit 15, for controlling the current source 17, and for making the current source 17 provide the current to the light unit 13. Practically, the dimming unit 19 receives the PWM signal transmitted by the switching circuit 153, and controls the current source 17 according to the PWM signal, which makes the current source 17 correspondingly provide different conduction currents according to the PWM signal and the turn-on voltage of the serial and/or parallel connections between the light sets 131.

For example, the dimming unit 19 may be a dimming switch SW 1, for turning on or off the current paths between the current source 17 and the light unit 13 according to the PWM signal generated by the switching circuit 153 of the control unit 15, and for controlling the average current flowing through each of the LEDs of the light unit 13, in order to implement the dimming processes. Therefore, the dimming unit 19 controls the current source 17 according to the PWM signal of the switching circuit 153. The current source 17 may also provide adjustable current source according to the controlling of the dimming unit 19. Moreover, the current source 17 correspondingly provides different conduction currents according to the differences between the serial and/or parallel connected light sets 131 and the PWM signal.

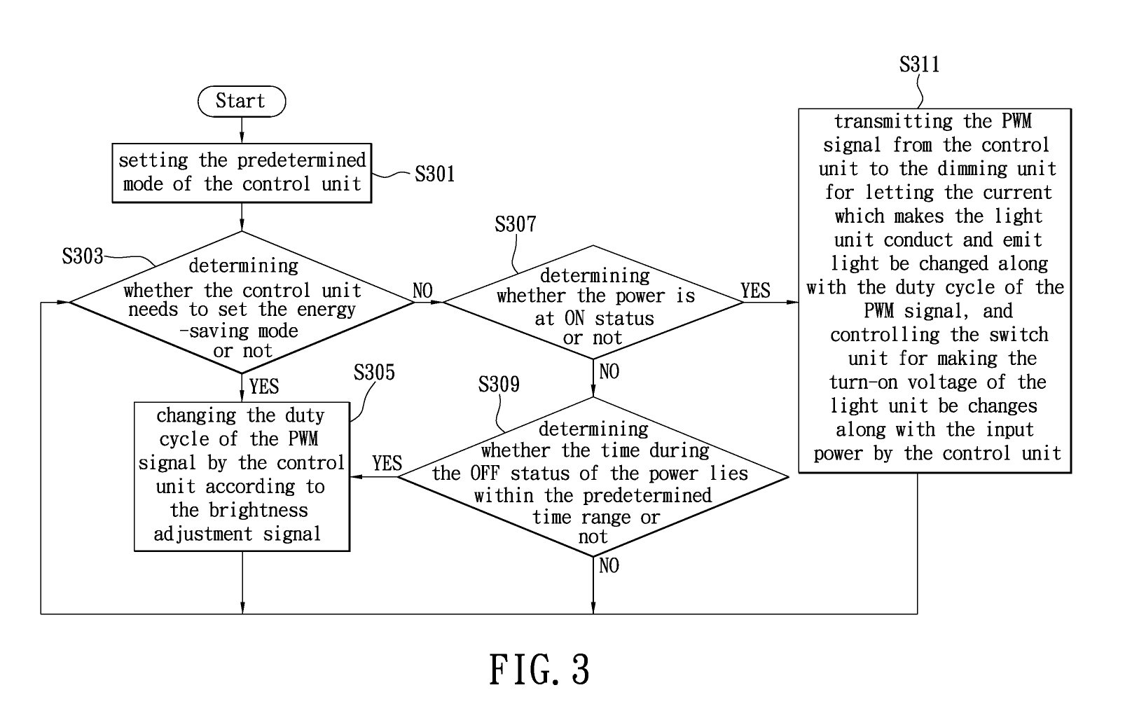

Please refer to FIG. 3 which is a flow chart of an energy-saving illumination method according to an embodiment of the present invention. Please also refer to the energy-saving illumination apparatus 1 in FIG. 2 along with FIG. 3, and for the convenience of explanation, the switch SW1 may be coupled to the AC power. The procedure in FIG. 3 includes the following steps. The control unit 15 is initially set to the predetermined mode (as step S301), in which the brightness adjustment signal of the predetermined mode is pre-set as the first signal. Then the control unit 15 may determine whether to set the energy-saving mode or not (as step S303). If the determination result is positive, the control unit 15 may change the duty cycle of the PWM signal according to the brightness adjustment signal (as step S305), for example, sets the brightness adjustment signal as the Nth signal.

Practically, after the control unit 15 sets the energy-saving mode, it may enter the energy-saving mode. If the control unit 15 wants to set the energy-saving mode, it may change the first signal to the third signal, then the third PWM signal may be transmitted to the light unit 13 through the switching circuit 153, which makes the light unit 13 output the third level of illumination brightness. In other embodiments, the user may use the infrared remote control device, the wireless radio frequency device, or the Bluetooth radio frequency to control the switch SW1 for allowing the switch SW1 to execute the ON-OFF operations. Alternatively, the user may use the button circuit connecting with the control unit 15, infrared remote control device, wireless radio frequency device, or Bluetooth radio frequency device to provide the signal to the control unit 15, for allowing the control unit 15 to enter and set the energy-saving mode. Although the present embodiment uses the switch SW1 for setting the energy-saving mode of the control unit 15, the scope of the present invention is not limited thereby.

In addition, the control unit 15 may change the duty cycle of the PWM signal according to the brightness adjustment signal (as step S305). Specifically, the brightness adjustment signal may be the Nth signal. The control unit 15 changes the duty cycle of the PWM signal according to the Nth signal, and generates corresponding Nth PWM signal. The duty cycle is the occupied time percentage which allows the light unit 13 to emit light during a time unit. For example, if the brightness adjustment signal is set as the first signal, the duty cycle of the first PWM signal has relatively longer light emitting time. Or, the brightness adjustment signal is set as the Nth signal, the duty cycle of the Nth PWM signal has relatively shorter light emitting time. Thus, the light unit 13 may have longer light emitting time according to the duty cycle of the first PWM signal than the duty cycle of the Nth PWM signal, therefore, the first level of the illumination brightness is lighter than the Nth level of the illumination brightness of the light unit 13.

In addition, the predetermined first signal may be serially switched to the Nth signal, and if the number exceeds N, the brightness adjustment signal may be set back to the first signal. Alternatively, the brightness adjustment signal may be directly set from the first signal to the Nth signal according to the requirements of the user. Therefore, the switching method may be freely designed by the one skilled in the art.

Practically, through the steps S305, S307, and S309, the control unit 15 forms a loop for setting the brightness adjustment signal. Moreover, if the AC power is at ON status in the step S307, determining that the time of the AC power in the OFF status is within a predetermined time range (as S309). If the determination result is positive, the control unit 15 may enter the step S305 for setting the duty cycle of the PWM signal according to the brightness adjustment signal. The predetermined time range is the time range between a first predetermined time and a second predetermined time.

For example, the energy-saving illumination apparatus 1 includes a switch SW1. The switch SW1 electrically connects with the current AC power for switching the ON-OFF operations. In addition, for the convenience of explanation, the present embodiment uses the first signal which are serially switched to the Nth signal. When the switch SW1 executes three times of ON status and two times of OFF status, and when the switch SW1 is at the OFF status for the first time, the control unit 15 determines that the time of the AC power with OFF status is between the first predetermined time and the second predetermined time (as step S309). If yes, the control unit 15 may adjust the first signal to the second signal.

Of course, when the switch SW1 is at the OFF status for the second time, the control unit 15 may determine that the time of the AC power which is at the OFF status is between the first predetermined time and the second predetermined time (as step S309). If the determination result is positive, the control unit 15 then adjusts the second signal into the third signal. After that, if the AC power is at ON status in step S307, the control unit 15 may control the duty cycle of the PWM signal according to the brightness adjustment signal. In this case, the brightness adjustment signal is adjusted to the third signal, thus the control unit 15 generates the third PWM signal corresponding to the third signal. Then the control unit 15 may transmit the third PWM signal to the dimming unit 19. The dimming unit 19 controls the current source 17 according to the third PWM signal, for allowing the current source 17 to provide the current making the light unit 13 emit light. Therefore, the light unit 13 is adjust to output the third level of illumination brightness.

Practically, the first predetermined time is the upper limit time of the AC power in the OFF status. For example, the user presses the switch SW1 for ON-OFF operations. If the time that the switch SW1 is set to OFF status exceeds the first predetermined time, the control unit 15 may determine not to set the energy-saving mode.

On the other hand, the second predetermined time is the lower limit time of the AC power in the OFF status. For example, the user presses the switch SW1 for ON-OFF operations. If the time that the switch is set to OFF status exceeds the second predetermined time and is smaller than the first predetermined time, the control unit 15 may determine to set the energy-saving mode. Thus, the control unit 15 enters and sets the energy-saving mode. In addition, the second predetermined time may avoid the wrong determination caused by the unsteady power supply, and the control unit 15 may enters the energy-saving mode correctly by precisely determining the time when the user presses the switch SW1.

The first predetermined time and the second predetermined time are the upper limit and the lower limit respectively of the OFF status of the AC power. Thus, the first predetermined time is larger than the second predetermined time, for example, the first predetermined time may be 10 seconds and the second predetermined time may be 1 second.

For example, if the time of the user closing the power of the energy-saving illumination apparatus 1 exceeds the first predetermined time, the energy-saving illumination apparatus 1 may not enter the energy-saving mode when the user turns it on. In addition, if the power system provides unstable power to the energy-saving illumination apparatus 1 and the time of the OFF status of the AC power does not exceed the second predetermined time, the energy-saving illumination apparatus 1 may still remain the original illumination brightness and may not enter the energy-saving mode. Thus, the values and manners of setting up the first predetermined time and the second predetermined time may be freely designed by the one skilled in the art according to the actual needs.

If the user presses the switch SW1 and makes the time of the ON-OFF operations lie between the first predetermined time and the second predetermined time, the first signal are serially converted to the second signal, the second signal are serially converted to the third signal, the third signal are serially converted to the Nth signal, and the Nth signal are serially converted to the first signal. Thus, the conversions from the first signal to the Nth signal form a loop, and the loop may change the brightness adjustment signal according to the ON-OFF operations of the switch SW1, for letting the control unit 15 to control the duty cycle of the PWM signal according to the brightness adjustment signal.

Therefore, the control unit 15 may form a loop for setting the brightness adjustment signal through the steps S305, S307, and S309. The operation times of the ON-OFF operations executed by the switch SW1 make the control unit 15 enter the energy-saving mode for changing the brightness adjustment signal, and the different brightness adjustment signal is corresponding to the different PWM signal with different duty cycle. For example, if the brightness adjustment signal is set as the Nth signal, the control unit 15 may generate the Nth PWM signal according to the Nth signal. Then if the determination result in step S307 is positive, the control unit 15 transmits the PWM signal to the dimming unit 19, thus the dimming unit 19 may adjust the current making the light unit 13 emit light to change along with the duty cycle of the PWM signal. The control unit 15 controls the switch unit 133 according to the detection result of the detection unit 11, for allowing the turn-on voltage of the light unit 13 to change along with the input power (as S311).

Practically, the control unit 15 controls the changes of the duty cycle of the PWM signal according to the Nth signal, and transmits the Nth PWM signal to the dimming unit 19. The dimming unit 19 controls the current source 17 according to the Nth PWM signal, for allowing the current source 17 to provide the current to the light unit 13. Thus, the light unit 13 may be adjusted and output the Nth level of illumination brightness. The first level of illumination brightness may be 100% brightness, the second level of illumination brightness may be 90% brightness, and the Nth level of illumination brightness may be N % brightness. It is worth noting that the first to Nth level of illumination brightness indicate that every LEDs of the light unit 13 are wholly changing lighter or darker.

It is worth noting that, in other embodiments, the switch SW1 is coupled between the rectification unit 10 and the light unit 13, and in step S307, it determines that the input power is at ON status or not; and in step S309, it determines the time of the input power in OFF status lies within the predetermined time range or not. Thus, the control unit 15 may determine the ON or OFF statuses of the input power along with the coupling of the switch SW1, for making the control unit 15 adjust the duty cycle of the PWM signal according to the brightness adjustment signal.

In addition, in other embodiments, the user may use the infrared remote control device, wireless radio frequency device, or Bluetooth radio frequency device for controlling the switch SW1, in order to allow the switch SW1 to execute ON-OFF operations. Alternatively, the user may use the button circuit connecting with the control unit 15, the infrared remote control device, wireless radio frequency device, or Bluetooth radio frequency device for providing signal to the control unit 15. Thus, the control unit 15 may omit the step S309 in FIG. 3. The control unit 15 determines whether to set the energy-saving mode or not in step S303. If the determination result is positive, the step S305 may be executed for changing the duty cycle of the PWM signal.

After that, in step S307, if the AC power or the input power is at ON status, the step S311 is executed. If the AC power or the input power is not at ON status, the energy-saving illumination apparatus 1 is turned off and does not output illumination brightness. Thus, the user may use the button circuit connecting with the control unit 15, the infrared remote control device, the wireless radio frequency device, or the Bluetooth radio frequency device for freely setting the brightness of the energy-saving illumination apparatus 1. The steps using the switch SW1 for setting the energy-saving mode is just an example, and the scope of the present invention is not limited thereby.

[Another Exemplary Embodiment of an Energy-Saving Illumination Apparatus According to the Present Invention]

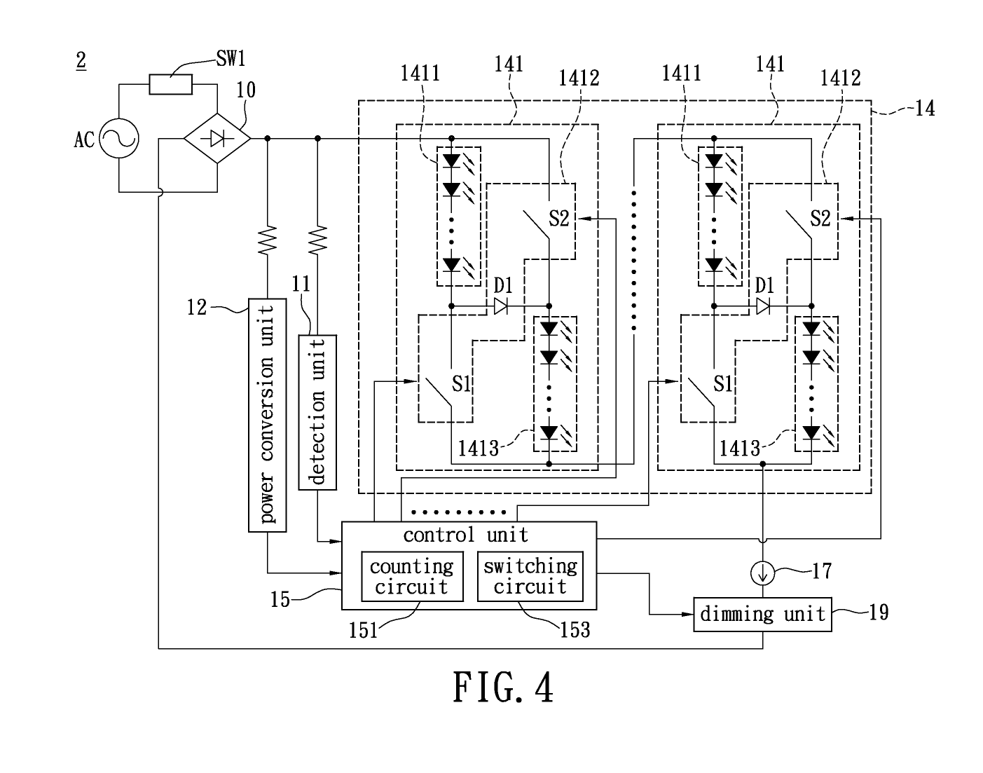

FIG. 4 shows a block diagram of an energy-saving illumination apparatus combining with a power supply according to another embodiment of the present invention. The energy-saving apparatus 2 may include a switch SW1, a rectification unit 10, a detection unit 11, a power conversion unit 12, a light unit 14, a control unit 15, a current source 17, and a dimming unit 19. The rectification unit 10 is coupled to the detection unit 11, the power conversion unit 12, and the light unit 14. The control unit 15 is coupled to the detection unit 11, the power conversion unit 12, the light unit 14, and the dimming unit 19.

The rectification unit 10 is used for rectifying the waveform of the AC power to the input power which can be used by the light unit 14. The input power may be a full-wave pulse DC.

The detection unit 11 detects the status of the input power. In an embodiment, the detection unit 11 may be a phase detection circuit or a voltage detection circuit. The power conversion unit 12 is used for converting the input power into a DC power with fixed voltage for providing to the control unit 15.

The light unit 14 includes several LED modules 141 connecting serially with one another, and each LED module 141 includes several light sets 131 and a switch circuit 1412. In an embodiment, the light sets 131 of the LED module 141 is described by the numbers of the first light set 1411 and the second light set 1413 as an example. The first light set 1411 and the second light set 1413 respectively includes several LEDs with same numbers and connecting serially with one another, and each light set 131 may receive the input power and emit light when the voltage of the input power exceeds the turn-on voltage of the light set 131.

The switch circuit 1412 further includes a first switch component S1, a second switch component S2, and a one-way conduction component D1. The first switch component S1 is coupled to one end of the first light set 1411, the second switch component S2 is coupled to one end of the second light set 1413, and the one-way conduction component D1 is coupled between the first light set 1411 and the second light set 1413. The first switch component S1 and the second switch component S2 may be mechanical switches or electrical switches. If the first and the second switches are electrical switches, they may be implemented by Darlington circuits. The one-way conduction component D1 may be a diode. The mentioned circuit implementations are not for limiting the scope of the present invention.

The operation manners of the switch circuit 1412 are as follows. When the components S1 and S2 are turned off, the first light set 1411, the one-way conduction component D1, and the second light set 1413 are successively and serially connected, and they are conduct-able. When the first switch component S1 and the second switch component S2 are turned on, the first light set 1411 and the second light set 1413 are connected in parallel connection, and the one-way conduction component D1 are not conduct-able. It is worth noting that, the structure of the mentioned switch circuit 1412 is just for an example of the switch unit used in the light unit 14, and is not for limiting the scope of the present invention.

Specifically, the first light set 1411 and the second light set 1413 of each LED module 141 may be connected in serial or parallel connection by the controlling of the switch circuit 1412. That is, the turn-on voltage of the light unit 14 may be adjusted between the highest turn-on voltage and the lowest turn-on voltage. For example, as the light unit 14 shown in FIG. 4, when the first light set 1411 and the second light set 1413 in each LED module 141 are connected in parallel connection, the lowest turn-on voltage of the light unit 14 is n multiplying with the turn-on voltage of one single light set. The number n is the number of LED modules 141 in the light unit 14. The highest turn-on voltage is two n multiplying with the turn-on voltage of one single light set.

The control unit 15 controls each switch circuit 1412 according to the detection result of the detection unit 11. The control manners of the switch circuits 1412 may include turning all of the first switch components S1 and the second switch components S2 on or off, or partially turning the first switch components S1 and the second switch components S2 on or off. The scope of the present invention is not limited thereby.

In an embodiment, the control unit 15 may set one or more sets of predetermined values between the highest turn-on voltage and the lowest turn-on voltage of the light unit 14, and each set of the predetermined values may correspond to one kind of control manner of the switch circuits 1412. Thus, practically, the control unit 15 may acquire the status of the input power according to the detection result of the detection unit 11, and determine whether there is a set of predetermined value matches or not. If the detection result is positive, the turn-on voltage of the light unit 14 which can be conducted under the presently inputted voltage of the input power is properly adjusted according to the control manner of the switch circuits 1412 corresponding to the matched set of predetermined values.

In addition, the control unit 15 may control the parallel and/or serial connections of the LED modules 141 according to the time counting. The counting time sequence includes a first serial connection control time, a second serial connection control time, a first parallel connection control time, and a second parallel connection control time. For the convenience of explanation, the number of the LED modules 141 may be set to two. Thus, the light unit 14 includes a first set of LED module 141 and a second set of LED module 141, and the initial connection status of the first light set 1411 and the second light set 1413 of each LED module 141 is parallel connection.

For example, the control unit 15 controls the first set of LED module 141 to be serially connected according to the first serial connection control time, that is, controls the first and second switch components S1 and S2 to turn off, for making the first light set 1411 and the second light set 1413 of the first set of LED module 141 be serially connected with each other. The present turn-on voltage of the light unit 14 is V1.

Then, the control unit 15 controls the second set of LED module 141 to be serially connected according to the second serial connection control time, that is, the control unit 15 controls the first and second switch components S1 and S2 of the second set of LED module 141 to turn off, for making the first light set 1411 and the second light set 1413 of the second set of LED module 141 be serially connected with each other. The present turn-on voltage of the light unit 14 is V2.

The control unit 15 controls the first set of LED module 141 to be connected in parallel according to the first parallel connection control time, that is, controls the first and second switch components S1 and S2 to turn on, for making the first light set 1411 and the second light set 1413 of the first set of LED module 141 be connected in parallel with each other. The present turn-on voltage of the light unit 14 is V2.

After that, the control unit 15 controls the second set of LED module 141 to be connected in parallel according to the second parallel connection control time, that is, the control unit 15 controls the first and second switch components S1 and S2 of the second set of LED module 141 to turn on, for making the first light set 1411 and the second light set 1413 of the second set of LED module 141 be connected in parallel with each other. The present turn-on voltage of the light unit 14 is V1.

The aforementioned examples use one cycle of the input power (the phase of the input power from 0 degree to 180 degrees) for explanation. After that, the actions are executed during each cycle of the input power. In addition, when the control unit 15 adjusts the turn-on voltage of the light unit 14 through the switch circuit 1412, may also adjust the current of the current source 17 provided to the light unit 14.

On the other hand, as to the energy-saving illumination apparatus 2, the PWM signal may be adjusted for changing the conduction time of the light unit 14 within one single cycle time, to output different illumination brightness.

Specifically, the control unit 15 includes a counting circuit 151 and a switching circuit 153. The control unit 15 transmits a PWM signal to the dimming unit 19 through the switching circuit 153. Thus, the dimming unit 19 controls the current source 17 according to the PWM signal, for making the current source 17 provide the current making the first and second sets of LED modules 141 emit light. Therefore, the first and second sets of the LED modules 141 may be adjusted to output the Nth level of illumination brightness.

For example, the AC power connects to the rectification unit 10 through the switch SW1, and be provided to the control unit 15 and the light unit 14 through the power conversion unit 12 and the detection unit 11. The rectification unit 10 generates pulse voltage along with the ON-OFF-ON operation of the switch SW1. The pulse voltage may provide to the control unit 15 for counting the times of ON-OFF-ON operations of the switch SW1, which may be used for controlling the brightness of the light unit 14. When the pulse voltage is counted by the counting circuit 151 of the control unit 15, the switching circuit 153 of the control unit 15 then changes the duty cycle of the PWM signal. According to the conduction time of the duty cycle, the current limiting circuit of the light unit 14 may be controlled. If the output current of the light unit 14 is suppressed under a predetermined value, the illumination brightness of the light unit 14 may be controlled.

By using the implementation manner described above, every time when the user presses the ON-OFF-ON operations of the switch SW1, the light unit 14 may change the illumination brightness. If the user successively presses ON-OFF-ON . . . OFF-ON, the light unit 14 may be changed to the Nth illumination brightness. If the Nth illumination brightness matches the needs of the user, the switch SW1 may stop at the ON status. In addition, when the light is turned off, the switch SW1 may be stopped at the OFF status. If the OFF status of the switch SW1 remains and exceeds a first predetermined time, the next time when the switch SW1 is turned ON, it may restored to the predetermined first level of illumination brightness.

It's worth noting that the rectification unit 10, the detection unit 11, the power conversion unit 12, the light unit 14, the control unit 15, the current source 17, and the dimming unit 19 may be integrated into a whole illumination device. If the switch SW1 is not combined with the rectification unit 10, they may not occupy much space. Therefore, the switch SW1 may operate ON-OFF operation to switch the AC power, and the whole illumination device may output the Nth illumination brightness according to the ON-OFF status of the AC power.

[An Energy-Saving Illumination Method According to Another Exemplary Embodiment of the Present Invention]

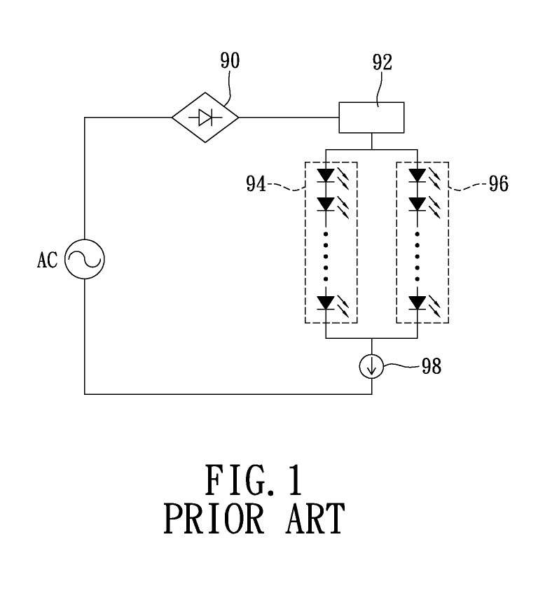

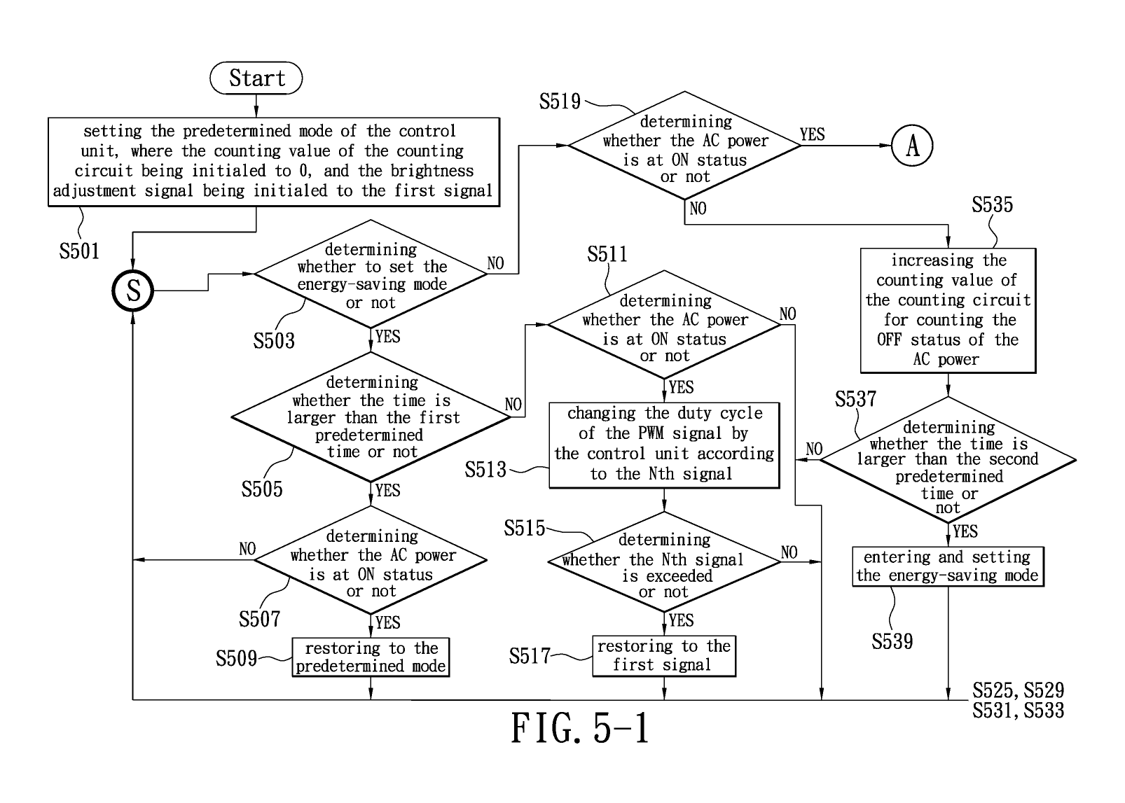

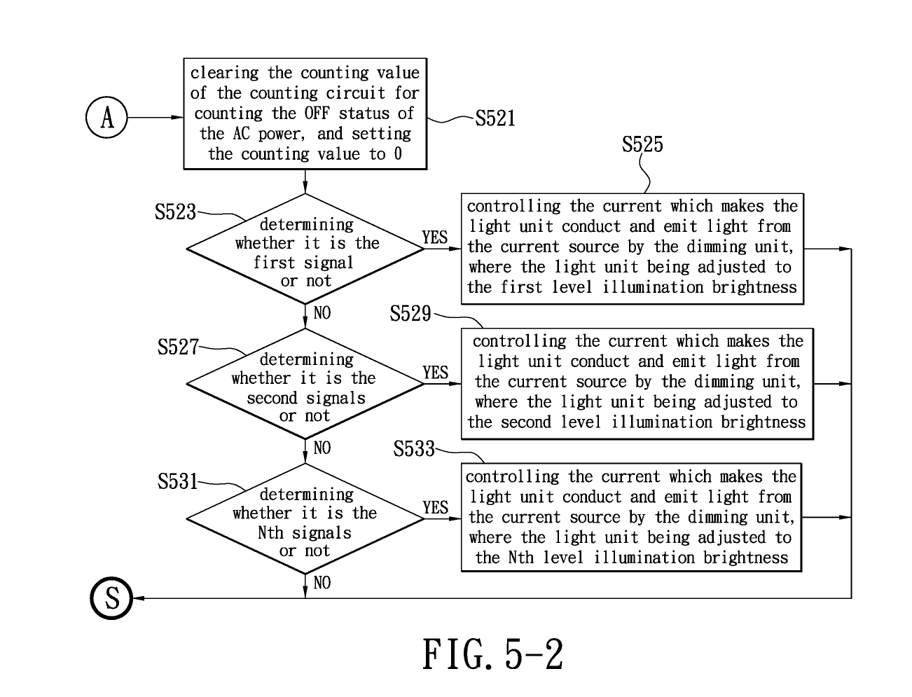

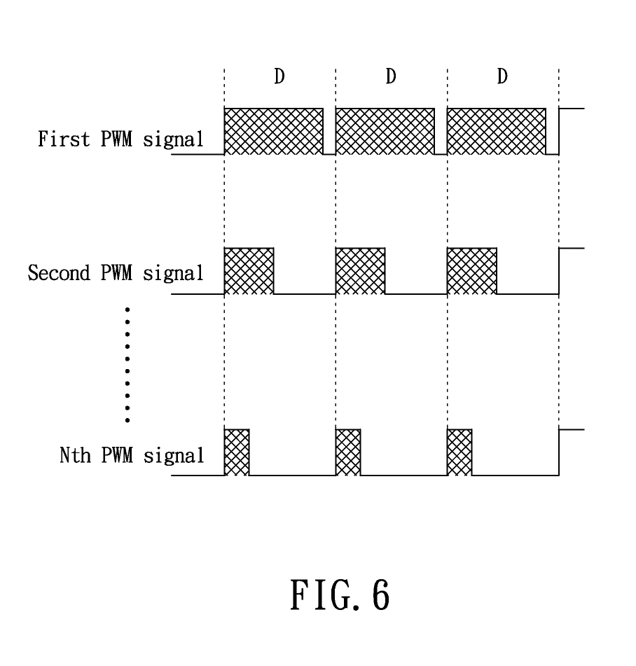

FIGS. 5-1 and 5-2 are flow charts of an energy-saving illumination method according to another embodiment of the present invention. Please refer to FIGS. 5-1 and 5-2. Please also refer to FIGS. 4 and 6 along with FIGS. 5-1 and 5-2. For the convenience of explanation, the following detection unit 11 may be a phase detection circuit and the control unit 15 may be MCU chip.

FIG. 6 shows a waveform diagram of the PWM signal according to an embodiment of the present invention. Before executing FIGS. 5-1 and 5-2, the energy-saving illumination apparatus 2 may transmit the PWM signal through the switching circuit 153 of the control unit 15, for controlling the dimming unit 19. The dimming unit 19 controls the current source according to the duty cycle D of the PWM signal, for making the current source provide the current to the light unit 14.

For example, the duty cycle D of the first PWM signal has more working time than the one of the second PWM signal. When the working time of the duty cycle D is longer, the time of the light unit 14 to emit light is also longer, so the total illumination brightness of the light unit 14 is lighter, for example, the working time of the duty cycle D of the first PWM signal is longer. When the working time of the duty cycle D is shorter, the time of the light unit 14 to emit light is also shorter, so the total illumination brightness of the light unit 14 is relatively darker, for example, the working time of the duty cycle D of the Nth PWM signal is shorter. Thus, the first level of illumination brightness is lighter than the Nth level of illumination brightness.

For example, when the control unit 15 transmits the first PWM signal for controlling the dimming unit 19, the average current provided by the current source 17 which is controlled by the dimming unit 19 is larger, for making the light unit 14 to output lighter first level illumination brightness. When the control unit 15 transmits the Nth PWM signal for controlling the dimming unit 19, the average current provided by the current source 17 which is controlled by the dimming unit 19 is smaller, for making the light unit 14 to output darker Nth level illumination brightness. Therefore, the control unit 15 uses the duty cycle D of the PWM signal for controlling the dimming unit 19, for further adjusting the light unit 14 to output the Nth level of illumination brightness.

The processes of FIGS. 5-1 and 5-2 are as follows. The control unit 15 is set to the predetermined mode, the counting value of the counting circuit 151 is set to 0, and the brightness adjustment signal is set to the first signal (as step S501). Then, the control unit 15 determines whether to set the energy-saving mode or not (as step S503). Of course, after the control unit 15 sets the energy-saving mode, it then enters the energy-saving mode. For example, the control unit 15 enters the energy-saving mode according to the ON-OFF switching times of the switch SW1, and the brightness adjustment signal of the energy-saving mode may change along with the ON-OFF operation of the switch SW1. In addition, the control unit 15 changes the duty cycle of the PWM signal according to the brightness adjustment signal, and makes the light unit 14 conduct and emit the Nth level of illumination brightness. If the control unit 15 determines not to set the energy-saving mode, the determination in step S519 is executed. If the AC power is ON, the control unit 15 may transmit the first PWM signal to the dimming unit 19 in the predetermined mode, and the light unit 14 may output the first level of illumination brightness.

In addition, if the time of the OFF status of the AC power exceeds the first predetermined time in step S505, the determination for determining whether the AC power is ON is executed (as step S507). If the determination result is positive, the control unit 15 is restored to the predetermined mode, and the brightness adjustment signal is restored to the predetermined first signal (as step S509). If the determination result of step S507 is negative, the determination in step S503 is then executed.

If the control unit 15 wants to set the energy-saving mode, in step S505, the determination for determining whether the time of the OFF status of the AC power is larger than the first predetermined time is executed. If the time of the OFF status of the AC power is smaller than the first predetermined time, then determines whether the AC power is at ON status or not (as step S511). If the determination result is yes, the control unit 15 changes the duty cycle of the PWM signal according to the Nth signal (as step S513). Then, determines whether the Nth signal is exceeded (as step S515). If the determination result is yes, the brightness adjustment signal is restored to the predetermined first signal (as step S517). If the determination result in step S511 or S515 is negative, the control unit 15 may goes back to the step S503.

If the control unit 15 is going to set the energy-saving mode, the determination of determining whether the AC power is at ON status is executed (as step S519). If the determination result is no, the counting value of the counting circuit 151 for counting the OFF status of the AC power is increased (as step 535). Then the step S537 is executed, for determining whether the time of the OFF status of the AC power is larger than the second predetermined time. If the time of the OFF status of the AC power is smaller than the second predetermined time, the control unit 15 enters and sets the energy-saving mode (as step S39). When the control unit 15 finishes the setting of the energy-saving mode, the next process is then executed.

If the determination result in step S519 is yes, the control unit 15 clears the counting value of the counting circuit 151, and sets the counting value to 0 (as step S521). Practically, the counting circuit 151 counts according to the ON-OFF operations of the switch SW1. When the determination result of step S519 is positive, the setting of the energy-saving mode is completed. Thus, the counting value of the counting circuit 151 is cleared, for allowing the re-counting when the user presses the switch SW1 ON or OFF again, and the control unit 15 may further determine the first signal, the second signal, or the Nth signal.

Specifically, in step S523, the determination of determining whether the brightness adjustment signal is the first signal or not is executed. If the result is yes, the control unit 15 controls the changes of the duty cycle of the PWM signal according to the first signal. Then the control unit 15 transmits the first PWM signal to the dimming unit 19, and the dimming unit 19 may control the current source 17 according to the first PWM signal, for making the current source 17 provide the current to the light unit 14. Therefore, the light unit 14 outputs the first level of illumination brightness (as step S525). If the result in step S523 is negative, the determination of determining whether the brightness adjustment signal is the second signal or not is executed (as step S527). If the result is yes, the control unit 15 controls the changes of the duty cycle of the PWM signal according to the second signal, and transmits the second PWM signal to the dimming unit 19. The dimming unit 19 then controls the current source 17 according to the second PWM signal for providing the current to the light unit 14. Therefore, the light unit 14 may be adjusted to output the second level of illumination brightness (as step S529).

If the determination result in step S529 is no, the determination of determining whether the brightness adjustment signal is the Nth signal is executed (as step S531). If the result is yes, the control unit 15 controls the changes of the duty cycle of the PWM signal according to the Nth signal, and transmits the Nth PWM signal to the dimming unit 19. The dimming unit 19 then controls the current source 17 according to the Nth PWM signal for providing the current to the light unit 14. Therefore, the light unit 14 may be adjusted to output the Nth level of illumination brightness (as step S533).

For example, the duty cycle D of the second PWM signal has 90% working time of the one of first PWM signal. Thus, the second level of illumination brightness is 90% of the first level of the illumination brightness. The duty cycle D of the Nth PWM signal has N % working time of the one of first PWM signal. Thus, the Nth level of illumination brightness is N % of the first level of the illumination brightness.

Therefore, the user may set the Nth signal by operating the ON-OFF of the switch SW1. For example, the brightness adjustment signal is set to the eighth signal. When the control unit 15 determines that the brightness adjustment signal is the eighth signal, the control unit 15 then transmits the eighth PWM signal to the dimming unit 19. The dimming unit 19 controls the current source 17 according to the eighth PWM signal for providing the current to the light unit 14. Thus, the light unit 14 may be adjust to output the eighth level of illumination brightness.

[Another Exemplary Embodiment of an Energy-Saving Illumination Apparatus]

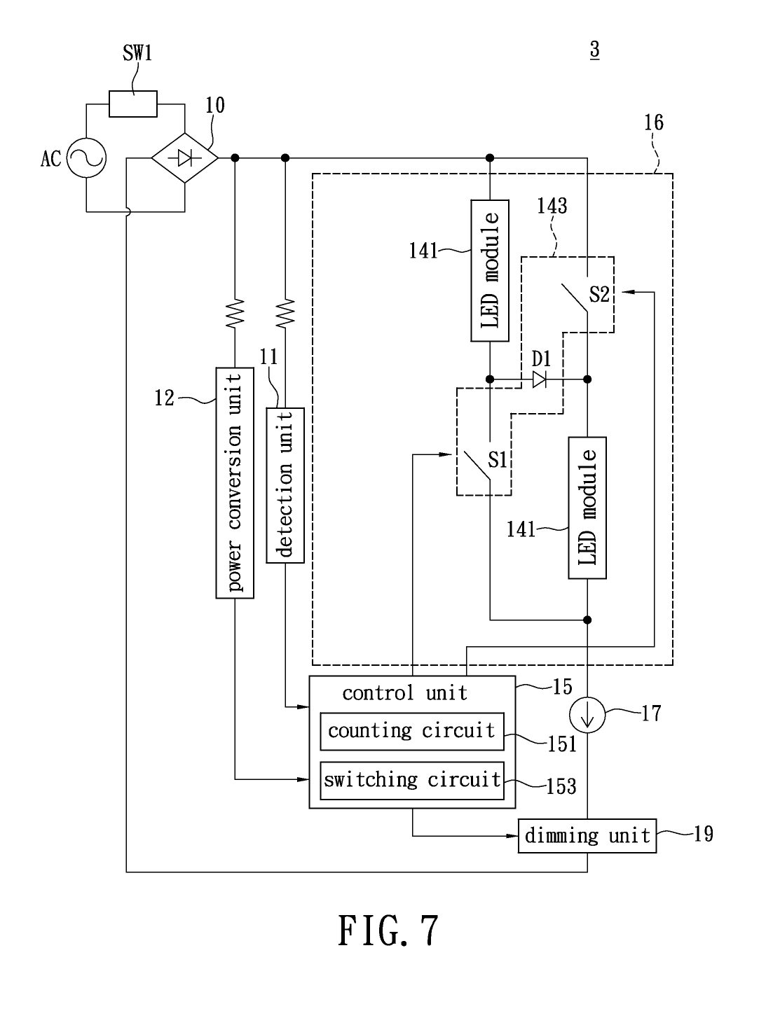

FIG. 7 shows a block diagram of an energy-saving illumination apparatus according to another embodiment of the present invention. Please refer to FIG. 7. The difference between FIG. 7 and FIG. 4 is that the light unit 16 of the energy-saving illumination apparatus 2 in FIG. 7 has two sets of LED modules 141, and the LED modules 141 may be connected with each other in serial or parallel connection through the switch circuit 143. The remaining parts of the apparatus are the same in the two figures and are not described repeatedly.

[Possible Efficacies of the Embodiments]

On the basis of the above, the present invention uses the control unit for transmitting the PWM signal to adjust the illumination brightness of the light unit. For example, the control unit may change the duty cycle of the PWM signal according to the brightness adjustment signal, and transmit the PWM signal to the dimming unit. The dimming unit controls the current source according to the PWM signal, for providing the current which makes the light unit conduct and emit light to the light unit. Then the light unit may be adjusted to output the Nth level of illumination brightness. Thus, the energy-saving illumination apparatus may adjust the brightness adjustment signal by using the switch, for making the light unit to wholly output and adjust the different levels of illumination brightness, which may solve the problem of unequal region brightness.

Some modifications of these examples, as well as other possibilities will, on reading or having read this description, or having comprehended these examples, will occur to those skilled in the art. Such modifications and variations are comprehended within this disclosure as described here and claimed below. The description above illustrates only a relative few specific embodiments and examples of the present disclosure. The present disclosure, indeed, does include various modifications and variations made to the structures and operations described herein, which still fall within the scope of the present disclosure as defined in the following claims.

What is claimed is:

1. An energy-saving illumination apparatus which receives an input power, comprising:
a light unit having a plurality of light sets and a switch unit for making the light sets be connected with each other in serial connection and/or parallel connection;
a detection unit for detecting a status of the input power inputting into the light unit;
a dimming unit, coupled to the light unit, for controlling a current of the light unit; and
a control unit coupled between the detection unit, the switch unit, and the dimming unit;
wherein the control unit controls the switch unit according to a detection result of the detection unit, for making a turn-on voltage of the light unit be changed along with the input power, and the control unit controls a duty cycle of a pulse width modulation (PWM) signal and transmits the PWM signal to the dimming unit, for making the dimming unit adjust the current conducting the light unit to be changed along with the duty cycle of the PWM signal.

2. The energy-saving illumination apparatus according to claim 1, wherein the control unit controls the change of the duty cycle of the PWM signal according to a brightness adjustment signal.

3. The energy-saving illumination apparatus according to claim 2, wherein the control unit generates the brightness adjustment signal when the detection unit detects a time that the input power is controlled by a switch for stopping inputting into the light unit is kept within a predetermined time range.

4. The energy-saving illumination apparatus according to claim 3, wherein the control unit includes a counting circuit and a switching circuit; the counting circuit counts the time that the input power stops inputting into the light unit according to the detection result of the detection unit, and generates the brightness adjustment signal when the time that the input power stops inputting into the light unit lies within the predetermined time range; the switching circuit adjusts the duty cycle of the PWM signal according to the brightness adjustment signal.

5. The energy-saving illumination apparatus according to claim 2, wherein the controlling of the control unit for changing the duty cycle of the PWM signal is by selecting one of a plurality of predetermined duty cycles.

6. The energy-saving illumination apparatus according to claim 1, further comprising a current source, coupled between the light unit and the dimming unit, for providing the current to the light unit and for making the light unit conduct and emit light.

7. The energy-saving illumination apparatus according to claim 2, wherein the brightness adjustment signal is inputted through a button circuit connecting with the control unit.

8. The energy-saving illumination apparatus according to claim 2, wherein the brightness adjustment signal is wirelessly transmitted from a wireless transmitter to the control unit.

9. The energy-saving illumination apparatus according to claim 1, wherein the control unit acquires a cycle time of the input power through the detection unit, and sets a plurality sets of predetermined time values in the cycle time; wherein each set of the predetermined time values is correspondence to a circuit control manner of the switch unit, and when the counting matches one set of the predetermined time values, the control unit controls the switch unit according to the circuit control manner which corresponds to the set of the predetermined time values.

10. The energy-saving illumination apparatus according to claim 1, wherein the control unit acquires a voltage change of the input power through the detection unit, and determines whether a voltage of the input power matches a predetermined value or not; if the determination result is positive, the control unit controls the switch unit according to a circuit control manner corresponding to the predetermined value.

11. An energy-saving illumination apparatus which receives an input power, comprising:
a light unit having a plurality of light emitting diode (LED) modules which are coupled to each other, and each LED module including:
a first light set including a plurality of first LEDs which are connected in serial connections;
a second light set including a plurality of second LEDs which are connected in serial connections;
a switch circuit, coupled between the first light set and the second light set, for connecting the first light set and the second light set in serial connection or parallel connection;
a detection unit for detecting a status of the input power inputted into the light unit;
a dimming unit, coupled to the light unit, for controlling a current of the light unit; and
a control unit coupled between the detection unit, the switch unit, and the dimming unit;
wherein the control unit controls the switch unit according to a detection result of the detection unit, for making a turn-on voltage of the light unit be changed along with the input power, and the control unit controls a duty cycle of a pulse width modulation (PWM) signal and transmits the PWM signal to the dimming unit, for making the dimming unit adjust the current conducting the light unit to be changed along with the duty cycle of the PWM signal.

12. The energy-saving illumination apparatus according to claim 11, wherein the control unit controls the change of the duty cycle of the PWM signal according to a brightness adjustment signal.

13. The energy-saving illumination apparatus according to claim 12, wherein the control unit generates the brightness adjustment signal when the detection unit detects a time that the input power is controlled by a switch for stopping inputting into the light unit is kept within a predetermined time range.

14. The energy-saving illumination apparatus according to claim 13, wherein the control unit includes a counting circuit and a switching circuit; the counting circuit counts the time that the input power stops inputting into the light unit according to the detection result of the detection unit, and generates the brightness adjustment signal when the time that the input power stops inputting into the light unit lies within the predetermined time range; the switching circuit adjusts the duty cycle of the PWM signal according to the brightness adjustment signal.

15. The energy-saving illumination apparatus according to claim 12, wherein the controlling of the control unit for changing the duty cycle of the PWM signal is by selecting one of a plurality of predetermined duty cycles.

16. The energy-saving illumination apparatus according to claim 11, further comprising a current source, coupled between the light unit and the dimming unit, for providing the current to the light unit and for making the light unit conduct and emit light.

17. The energy-saving illumination apparatus according to claim 12, wherein the brightness adjustment signal is inputted through a button circuit connecting with the control unit.

18. The energy-saving illumination apparatus according to claim 12, wherein the brightness adjustment signal is wirelessly transmitted from a wireless transmitter to the control unit.

19. The energy-saving illumination apparatus according to claim 12, wherein the switch circuit includes:
a first switch component coupled to the first light set;
a second switch component coupled to the second light set; and
an one-way conduction component coupled between the first switch component and the second switch component;
wherein when the first switch component and the second switch component are turned on, the first light set and the second light set are connected in parallel connection; and
wherein when the first switch component and the second switch component are turned off, the first light set and the second light set are connected in serial connection, and the one-way conduction component is turned on.

20. The energy-saving illumination apparatus according to claim 12, wherein at least one switch circuit is coupled between the LED modules for controlling the LED modules to connect with one another in serial or parallel connections.

21. An energy-saving illumination method for controlling a light unit and a dimming unit through a control unit, wherein the light unit has a plurality of light sets and a switch unit for making the light sets connect in serial and/or parallel connections, and the dimming unit is for controlling the light unit to use a current source, comprising the steps of:
detecting a status of an input power which is a pulse direct current (DC) inputted into the light unit;
controlling the switch unit for making a turn-on voltage of the light unit change along with the input power based on the control unit according to the detection result of the input power; and
providing a pulse width modulation (PWM) signal to the dimming unit by the control unit, and controlling a duty cycle of the PWM signal, for making the dimming unit adjust the current conducting the light unit to be changed along with the duty cycle of the PWM signal.

22. The energy-saving illumination method according to claim 21, wherein the control unit controls the change of the duty cycle of the PWM signal according to a brightness adjustment signal.

23. The energy-saving illumination method according to claim 22, wherein the control unit generates the brightness adjustment signal when the detection unit detects a time that the input power is controlled by a switch for stopping inputting into the light unit is kept within a predetermined time range.

24. The energy-saving illumination method according to claim 22, wherein the controlling of the control unit for changing the duty cycle of the PWM signal is by selecting one of a plurality of predetermined duty cycles.

25. The energy-saving illumination method according to claim 21, wherein when detecting a cycle time of the input power, determining whether a counting matches a set of predetermined time value in the cycle time; if the determination result is positive, controlling the switch unit according to a circuit control manner corresponding to the set of predetermined time.

26. The energy-saving illumination method according to claim 21, wherein when detecting a voltage change of the input power, determining whether a voltage of the input power matches a predetermined value; if the determination result is positive, controlling the switch unit according to a circuit control manner corresponding to the predetermined value.
